(19) United States
(12) Patent Application Publication
(10) Pub. No.: US 2015/0371195 A1
(43) Pub. Date: Dec. 24, 2015

(54) VARIABLE FEEDBACK FOR CALENDAR RESCHEDULE OPERATIONS

(71) Applicant: International Business Machines Corporation, Armonk, NY (US)

(72) Inventors: Gregory J. Boss, Saginaw, MI (US); Andrew R. Jones, Round Rock, TX (US); Kevin C. McConnell, Austin, TX (US); John E. Moore, JR., Brownsburg, IN (US)

(21) Appl. No.: 14/311,678

(22) Filed: Jun. 23, 2014

(51) Int. Cl. G06Q 10/10

(52) U.S. Cl. CPC G06Q 10/1095

(57) ABSTRACT

A method for variable feedback for calendar reschedule operations. The method includes receiving a set of information for an event where the set of information details a first time slot associated with the event. The method includes calculating a rating value for each of a plurality of time slots based on the set of information. The method further includes receiving information to reschedule the first time slot to a second time slot. A resistance level is determined from the set of information and a relative feedback is applied based on the determined resistance level.

### BACKGROUND OF THE INVENTION

The present invention relates generally to the field of scheduling calendar events, and more particularly to variable feedback for calendar reschedule operations.

Calendar services may be implemented with various devices, such as computing devices, mobile devices, and touch-screen devices. Most calendar services are capable of creating calendar events from data input by a user, such as a time and date for an event, a proposed duration of the event, and desired invitees for the event. Many calendar services are capable of depicting time slots on a calendar as either “free,” indicating an event may be scheduled in that time slot, or “not free,” indicating the invitee is not available during that time slot.

Some calendar services are capable of accessing the calendars of the desired invitees for an event and determining which invitees are available during the proposed date and time for the event. Similarly, when an event is rescheduled, a calendar service reschedule operation may allow a user to check other invitee calendars for a best available time slot, as well as, allowing a user to query the calendar service to recommend a best available time slot which may accommodate all, or most, of the invitees.

### SUMMARY

According to one embodiment of the present invention, a method for variable feedback for calendar reschedule operations is provided. The method for variable feedback for calendar reschedule operations may include receiving a first set of information for a first event, where the first set of information details a first time slot associated with the first event. The method may include calculating a rating value for each of a plurality of time slots based on the first set of information. The method may include receiving information to reschedule the first time slot associated with the first event to a second time slot. The method may include determining a resistance level based on the first set of information and applying a relative feedback based on the determined resistance level.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a scheduling feedback program for providing relative feedback based on the rescheduling of a calendar entry, in accordance with an embodiment of the present invention;

FIG. 3A is an example of calendar events for an organization, listed by time and individual, displaying a calendar event rating value and an individual rating value for each invitee, in accordance with an embodiment of the present invention;

FIG. 3B is an example of calendar events by time, displaying a time slot rating for each calendar event, in accordance with an embodiment of the present invention; and

FIG. 4 depicts a block diagram of internal and external components of a data processing system, such as the computing device of FIG. 1, in accordance with an embodiment of the present invention.

### DETAILED DESCRIPTION

Currently, there are many functions within a calendar service that may help a user in scheduling and managing calendar events. When scheduling an event, a calendar service may recommend an available time slot, allow a user to check other invitee calendars, and provide feedback, such as messages, indicating whether one scheduled event conflicts with a second scheduled event of one or more of the invitees. Embodiments of the present invention seek to provide a method for variable levels of feedback in real time when rescheduling a calendar event based on a rating value of the time slot and the invitees.

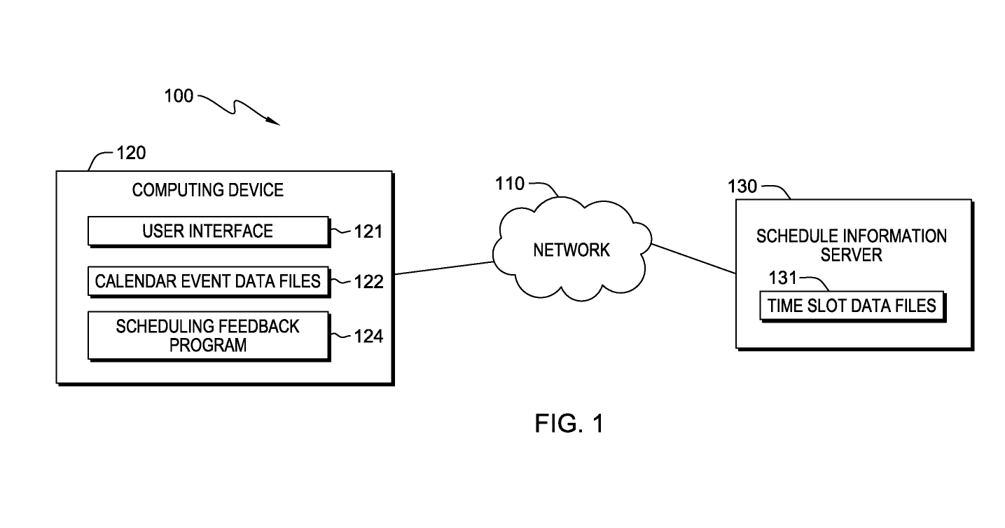

The present invention will now be described in detail with reference to the Figures. FIG. 1 is a functional block diagram illustrating a distributed data processing environment, generally designated 100, in accordance with one embodiment of the present invention. Modifications to distributed data processing environment 100 may be made by those skilled in the art without departing from the scope of the invention as recited by the claims. In an exemplary embodiment, distributed data processing environment 100 includes computing device 120 and schedule information server 130, all interconnected over network 110.

Network 110 can be, for example, a local area network (LAN), a wide area network (WAN) such as the Internet, or a combination of the two, and can include wired, wireless, or fiber optic connections. In general, network 110 can be any combination of connections and protocols that will support communication between computing device 120 and schedule information server 130.

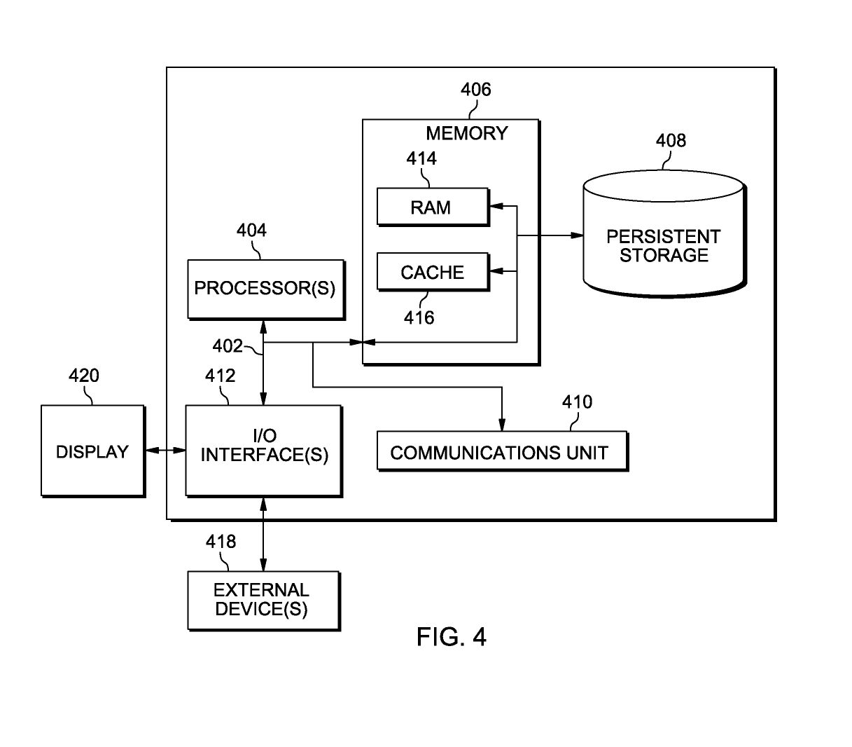

Schedule information server 130 contains time slot data files 131. Schedule information server 130 may be a management server, a web server, or any other electronic device or computing system capable of receiving and sending data. In other embodiments, schedule information server 130 can be a laptop computer, a tablet computer, a netbook computer, a personal computer (PC), a desktop computer, a personal digital assistant (PDA), a smart phone, or any programmable electronic device capable of communicating with computing device 120 via network 110, and with various components and devices within distributed data processing environment 100. In other embodiments of the present invention, schedule information server 130 can represent a computing system utilizing clustered computers and components to act as a single pool of seamless resources when accessed through a network. In the exemplary embodiment, schedule information server 130 is capable of processing requests for calendar event information from scheduling feedback program 124, located on computing device 120. Schedule information server 130 may include internal and external hardware components, as depicted and described in further detail with respect to FIG. 4.

Time slot data files 131 includes information detailing calculated information for a shared calendar. In the exemplary embodiment, time slot data files 131 includes information such as calendar event ratings for an organization, individual ratings for an organization, and calculated time slot ratings (further detailed below), among other information, for a shared calendar.

Computing device 120 includes user interface (UI) 121, calendar event data files 122, and scheduling feedback program 124. Computing device 120 may be a laptop computer, a tablet computer, a netbook computer, a personal computer (PC), a desktop computer, a personal digital assistant (PDA), a smart phone, a thin client, or any programmable electronic device capable of communicating with schedule information server 130 via network 110. Computing device 120 may include internal and external hardware components, as depicted and described in further detail with respect to FIG. 4.

UI 121 may be, for example, a graphical user interface (GUI) or a web user interface (WUI) and can display text, documents, web browser windows, user options, application interfaces, and instructions for operation and includes the information (e.g., graphic, text, and sound) a program presents to a user and the control sequences the user employs to control the program. In the exemplary embodiment, UI 121 allows a user to interact with scheduling feedback program 124 through electronic devices, such as a computer keyboard and/or cursor control devices, such as a computer mouse or touchpad, and through graphical icons and visual indicators, such as secondary notation, as opposed to text-based interfaces, typed command labels, or text navigation.

Calendar event data files 122 includes information detailing the event that is proposed by a user (e.g., a calendar event). In the exemplary embodiment, calendar event data files 122 includes detailed information about event ratings and individual ratings (further detailed below) for a particular organization. Calendar event data files 122 are stored on computing device 120 and may be retrieved when a user is creating a calendar event on computing device 120.

In the exemplary embodiment, scheduling feedback program 124 is a software application capable of receiving information, such as a user input, via UI 121. Although depicted as a separate component, in an embodiment, scheduling feedback program 124 may be partially or fully integrated with UI 121. In other embodiments, scheduling feedback program 124 is fully or partially integrated within a calendar program or service. In the exemplary embodiment, scheduling feedback program 124 is capable of communicating with schedule information server 130 and retrieving information, such as time slot data files 131, via network 110. Scheduling feedback program 124 is capable of creating calendar events from stored calendar event information, such as calendar event data files 122, calculating a time slot rating, storing the time slot rating as time slot data files 131, and communicating with UI 121 and/or external devices, such as a mouse device.

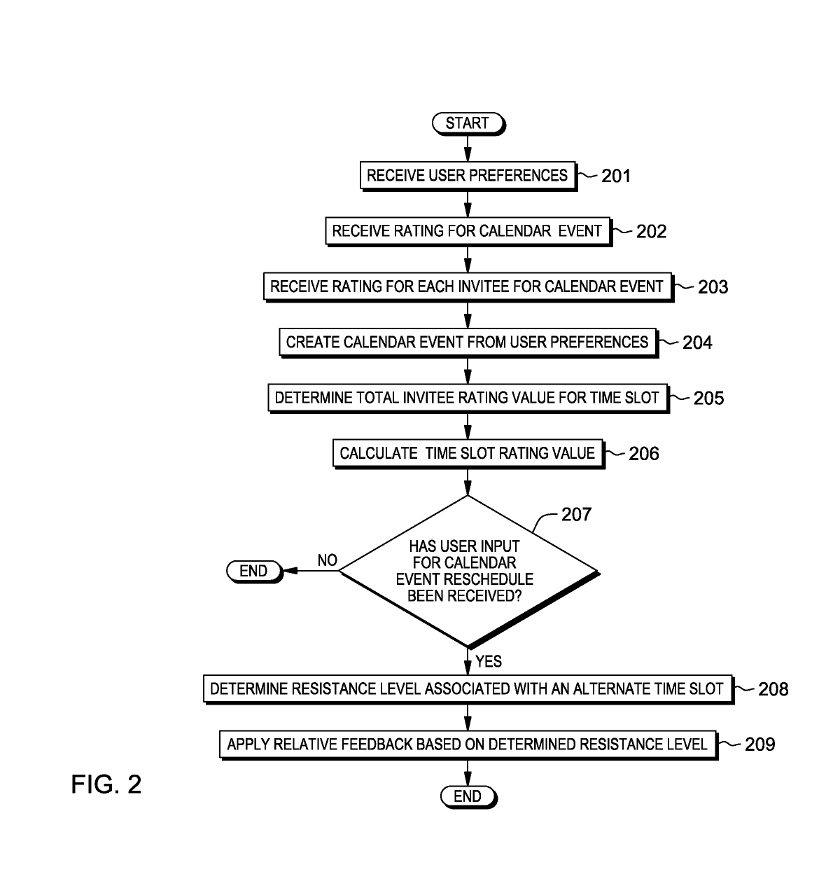

FIG. 2 is a flowchart depicting operational steps of scheduling feedback program 124 for providing relative feedback based on the rescheduling of a calendar entry, in accordance with an embodiment of the present invention.

Scheduling feedback program 124 receives a set of user preferences (step 201). In the exemplary embodiment, scheduling feedback program 124 receives user input detailing a proposed scheduling time period and a proposed time slot duration for scheduling feedback program 124 to evaluate. For example, scheduling feedback program 124 may receive a user input of 30 days into the future and 30 minute duration time slots to evaluate. In another embodiment, scheduling feedback program 124 defines a default number of days into the future and a default duration of each time slot to evaluate when no user preferences are received.

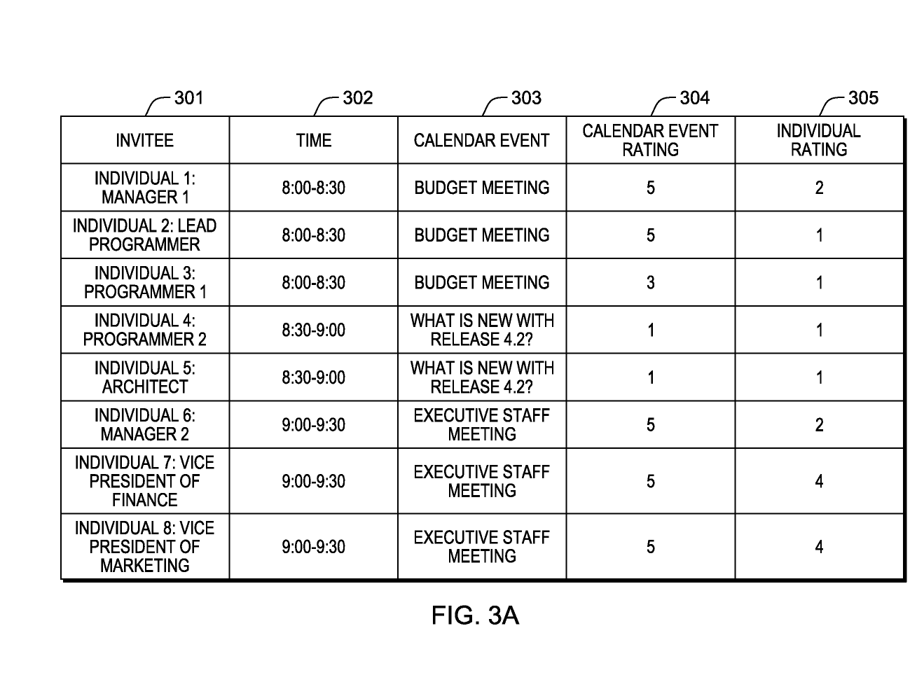

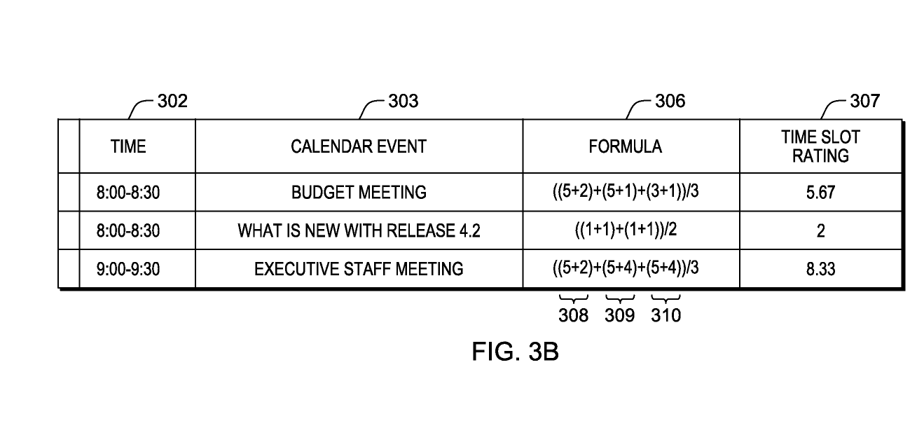

Scheduling feedback program 124 receives a rating for a calendar event from a user (step 202). In the exemplary embodiment, scheduling feedback program 124 receives user input detailing a calendar event rating value. For example, scheduling feedback program 124 may receive a user input rating of 5 for a calendar event, where 5 is the highest rating, indicating that the calendar event is important (discussed in FIG. 3A). The value of each rating for a calendar event may vary between different organizations, so long as the event ratings are consistent within each individual organization. In another embodiment, an individual organization, such as a business, defines the event ratings for the organization, so that scheduling feedback program 124 automatically associates an event rating value with a calendar event, based on the indicated preferences of the organization. For example, a business may define client meetings as a high priority and staff meetings as a low priority, so that when an event is created involving a client meeting, scheduling feedback program 124 automatically assigns the client meeting a high rating value, and when an event is created involving a staff meeting, scheduling feedback program 124 automatically assigns the staff meeting a low rating value. In yet another embodiment, scheduling feedback program 124 receives a rating value from a user input for a particular set of projects, in which a higher rating value is assigned to priority projects and a lower rating value is assigned to less important projects.

Scheduling feedback program 124 receives an individual rating for each invitee for a calendar event (step 203). In the exemplary embodiment, scheduling feedback program 124 receives user input detailing an individual rating value for each invitee to a calendar event, where the individual rating value is based on the role of the invitee in the organization. For example, scheduling feedback program 124 may receive input from a user detailing an individual rating of 4 for an executive invitee, where 4 is the highest rating, indicating that the executive is an important invitee (discussed in FIG. 3A). The value of each individual rating for an invitee may vary between different organizations, so long as the ratings are consistent within each individual organization. In another embodiment, an individual organization, such as a business, defines the individual ratings for the organization, so that the individual ratings are automatically input into a calendar event, based on the indicated preferences of the organization. For example, a business may define a president as a high rated invitee and a staff member as a low rated invitee, and when a set of invitees are invited to a calendar event, each of the invitees will automatically be assigned an individual rating value, based on the predefined preferences of the business.

Scheduling feedback program 124 creates a calendar event from the user preferences (step 204). In the exemplary embodiment, scheduling feedback program 124 creates a calendar event from the received information input by a user, detailing the event name and associated rating, the set of all invitees and associated individual ratings, the location, and the time. The created calendar event is displayed as a calendar entry, detailing, in text, the information associated with the event (as depicted in FIG. 3A).

Scheduling feedback program 124 determines a total invitee rating value for a time slot selected by a user (step 205). In the exemplary embodiment, scheduling feedback program 124 determines a total invitee rating value for a selected time slot, by adding together the calendar event rating (step 202) and the individual rating (step 203), for the selected time slot (discussed further in FIG. 3B). In another embodiment, scheduling feedback program 124 continuously determines a total invitee rating value for a range of time slots selected by a user. For example, using 30 minute time slots, scheduling feedback program 124 may determine a total invitee rating value for each successive 30 minute time slot for 30 days (1440 total invitee rating value determinations). In the exemplary embodiment, scheduling feedback program 124 determines a total invitee rating value for a time slot each time a new calendar event is created and each time an existing calendar event is rescheduled by a user.

Scheduling feedback program 124 calculates a time slot rating value for a time slot associated with a particular calendar event (step 206). In the exemplary embodiment, scheduling feedback program 124 adds together the total invitee rating value for each invitee to a calendar event and divides by the number of invitees (i.e., a mean calculation). The calculated time slot rating value is displayed in a calendar by a calendar program or service, via UI 121, with the associated event and time (discussed further in FIG. 3B). The calendar event information, including calculated time slot rating values, is stored on schedule information server 130, as time slot data files 131. In another embodiment, scheduling feedback program 124 continuously calculates a time slot rating value for a range of time slots, selected by a user. For example, using 30 minute time slots, scheduling feedback program 124 may determine a time slot rating value using the determined total invitee rating values, for each successive 30 minute time slot for 30 days (1440 time slot rating value calculations). In the exemplary embodiment, scheduling feedback program 124 calculates a time slot rating value for a time slot each time a new calendar event is created and each time an existing calendar event is rescheduled by a user.

Scheduling feedback program 124 determines whether user input for a reschedule of a calendar event has been received (decision block 207). In the exemplary embodiment, scheduling feedback program 124 receives user input when a calendar event moved by a user in the user interface is detected, indicating an attempt to reschedule the calendar event. For example, scheduling feedback program 124 may detect that a user has selected and moved an existing calendar event using a mouse device, by communicating with the operating system of the computing device, which can determine whether a selection using the mouse device has been made in the user interface or if the mouse device is hovering (i.e., stopping movement while the cursor is within the bounds of an area) over an area in the user interface. If scheduling feedback program 124 determines that no user input for a calendar event reschedule has been received (decision block 207, NO branch), then scheduling feedback program 124 exits.

If scheduling feedback program 124 determines that a user input for a calendar event reschedule has been received (decision block 207, YES branch), then scheduling feedback program 124 determines a resistance level associated with an alternate time slot (step 208). The resistance level of a time slot is a relative level indicating the effects of rescheduling a calendar event, which is based on the time slot rating value, the total invitee rating values, and the event rating values of an organization. In the exemplary embodiment, a high resistance level time slot indicates that a reschedule of a calendar event would affect many of the invitees, and a low resistance level time slot indicates that a reschedule of a calendar event would have no, or few, effects to the set of invitees. For example, many invitees may be affected when a calendar event is rescheduled to a high resistance level time slot, as the invitees may already have a different event scheduled during the high resistance level time slot. In the exemplary embodiment, the relative resistance level varies between different organizations, based on the predetermined ratings of each organization. For example, a time slot rating value of 10 may be considered a high resistance level at one organization, while a time slot rating value of 5 may be considered a high resistance level at a different organization. In the exemplary embodiment, scheduling feedback program 124 determines the relative resistance level of an alternate time slot when an existing calendar event is moved by a user within a close physical distance to the alternate time slot, in the user interface.

Scheduling feedback program 124 applies relative feedback based on the determined resistance level (step 209). In the exemplary embodiment, scheduling feedback program 124 applies a relative change to the user interface, based on the physical distance of a rescheduled calendar entry to a time slot, by altering one or more of: the visual characteristics in the user interface, an audio feedback, and/or the haptic feedback, among other changes.

In the exemplary embodiment, scheduling feedback program 124 visually displays a resistance level value in UI 121 indicating the resistance level for each time slot. For example, scheduling feedback program 124 may display a resistance level value between 0 and 5, where 0 is no resistance (open time slot) and 5 is very high resistance (indicating not to reschedule the time slot). In another embodiment, scheduling feedback program 124 displays a change in the outline of the time slot indicating the resistance level of the time slot. For example, to indicate a minimum resistance level, scheduling feedback program 124 may display no outline of the time slot; to indicate a low resistance level, scheduling feedback program 124 may display a dashed outline of the time slot; to indicate a medium resistance level, scheduling feedback program 124 may display a thin line as the outline of the time slot; and to indicate a high resistance level, scheduling feedback program 124 may display a thick line as the outline of the time slot. In other embodiments, scheduling feedback program 124 applies a change in the visual characteristics by changing the color of various elements within UI 121. For example, scheduling feedback program 124 may outline a high resistance level time slot in red indicating that it should not be rescheduled and may outline a low resistance level time slot in green indicating that it may be rescheduled. Scheduling feedback program 124 may display one or more changes to the visual characteristics in UI 121 to indicate a resistance level to a user.

In other embodiments, scheduling feedback program 124 provides a sound that indicates the resistance level of the time slot to a user. For example, scheduling feedback program 124 may have three different sounds; one sound which corresponds to a low resistance level time slot, a second sound which corresponds to a medium resistance level time slot, and a third sound which corresponds to a high resistance level time slot. In another embodiment, scheduling feedback program 124 provides a series of sounds which indicate feedback to the user as to the level of resistance of the time slot. For example, scheduling feedback program 124 may provide a series of sounds which may intensify in duration or frequency when scheduling feedback program 124 detects a calendar entry is near a high resistance level time slot while the intensity in duration or frequency may get lower when scheduling feedback program 124 detects a calendar entry is near a low resistance level time slot. In another example, scheduling feedback program 124 provides one sound which gets louder in volume as scheduling feedback program 124 nears a higher resistance level time slot and may get softer in volume as scheduling feedback program 124 nears a lower resistance level time slot. Scheduling feedback program 124 may implement one or more changes to the audible feedback characteristics to indicate the relative resistance level of a time slot to a user.

In other embodiments, scheduling feedback program 124 provides variable haptic feedback to a user to indicate the resistance level of the time slot. For example, scheduling feedback program 124 may implement a vibration of a device, such as a tablet device, where the vibrations are more frequent and/or have a higher intensity as scheduling feedback program 124 detects a higher resistance level time slot, and the vibrations are less frequent and/or have a lower intensity as scheduling feedback program 124 detects a lower resistance level time slot. In another embodiment, scheduling feedback program 124 provides variable haptic feedback through a mouse device. For example, scheduling feedback program 124 may communicate with a mouse device making it harder to move the mouse device in a high resistance level time slot by increasing the resistance in the trackball of the mouse device. In yet another embodiment, scheduling feedback program 124 communicates with UI 121 to cause a change to the surface of a touch device, such as a tablet, so that the action of sliding an object provides relative feedback to a user as to the resistance level of the time slot. For example, as a calendar event is moved toward a high resistance level time slot, scheduling feedback program 124 causes the user action of sliding the calendar event to become more difficult, or a rough movement in the user interface, indicating the calendar event is nearing a high resistance level time slot, or a less difficult, smoother movement in the user interface, indicating the calendar object is nearing a lower resistance level time slot. In another embodiment, scheduling feedback program 124 causes a variable level of resistance to a user when selecting and moving an object in UI 121. For example, scheduling feedback program 124 may require a user to click and hold a mouse device for: 2 seconds before a calendar event with a high resistance level becomes selectable; 1 second before a calendar event with a medium resistance level becomes selectable; and 300 milliseconds before a calendar even with a low resistance level becomes selectable. Scheduling feedback program 124 may implement one or more levels of haptic feedback to indicate the relative resistance level of a time slot to a user. Scheduling feedback program 124 may also alter one or more of visual characteristics, audio feedback, and haptic feedback at one time.

In the exemplary embodiment, a user selects which resistance feedback to receive from scheduling feedback program 124 when rescheduling a calendar event. For example, if a user is rescheduling an event on a mobile device while they are travelling, the user may want to receive both visual and haptic feedback from scheduling feedback program 124 when rescheduling a calendar event. In another example, if a user is in a quiet area, the user may want to receive only visual feedback and no audio or haptic feedback, which may be disruptive.

In an example, as an 8:00 a.m. meeting is moved to the 8:30 a.m. time slot, there is no resistance provided to a user, as there are no scheduled events during the 8:30 a.m. time slot, indicating that the user may reschedule to this time slot without creating a scheduling conflict for the invitees of the meeting. As the 8:00 a.m. meeting moves past the 8:30 a.m. time slot and becomes closer in physical distance to the 9:00 a.m. time slot, scheduling feedback program 124 applies the selected set of resistance feedback to the user to indicate that the user should not reschedule the event for the 9:00 a.m. time slot, as it creates a scheduling conflict for the invitees of the meeting, and the user may then choose a different time slot.

FIG. 3A is an example of calendar events for an organization, listed by time and individual, displaying a calendar event rating value and an individual rating value for each invitee, in accordance with an embodiment of the present invention. Invitee column 301 is a list of each individual, and the role of the individual within a particular organization. Time column 302 specifies the time slot, or range of time, over which a particular calendar event from calendar event column 303 will take place. Calendar event rating column 304 lists the calendar event ratings for each calendar event and each invitee from invitee column 301. Individual rating column 305 lists the individual ratings for each invitee from invitee column 301.

In the exemplary embodiment, the calendar event ratings for the organization are defined on a 0-5 rating scale, with a 0 rating indicating an open time slot, a 1 rating indicating an informational meeting at which attendance is optional, a 2 rating indicating an informational meeting at which attendance is requested, a 3 rating indicating an issues or actions meeting at which attendance is required, a 4 rating indicating a customer meeting at which attendance is required, and a 5 rating indicating not to reschedule the calendar event. In the exemplary embodiment, the individual ratings for the organization are defined on a 1-4 rating scale, with a 1 rating associated with a staff member, a 2 rating associated with a manager, a 3 rating associated with a director, and a 4 rating associated with a vice president. For example, the calendar event Executive Staff Meeting from calendar event column 303 has the corresponding time of the event, 9:00-9:30, listed in time column 302, and the corresponding invitees to the calendar event are listed in invitee column 301. Each invitee has an associated calendar event rating in calendar event rating column 304 and an associated individual rating in individual rating column 305. For example, individual 6 is a manager within the organization and has a 5 calendar event rating and a 2 individual rating (associated with a manager position in the example organization) indicating not to reschedule the calendar event Executive Staff Meeting. Individual 7 is a vice president of finance within the organization and has a 5 calendar event rating and a 4 individual rating (associated with a vice president position in the example organization) indicating not to reschedule the calendar event Executive Staff Meeting.

FIG. 3B is an example of calendar events by time, displaying a time slot rating for each calendar event, in accordance with an embodiment of the present invention. Time slot rating column 307 lists the time slot ratings associated with a calendar event (listed in calendar event column 303) at a specified time range (listed in time column 302). The time slot ratings are calculated using the formula listed in formula column 306, which takes an average of the total invitee rating values 308, 309, and 310 for each invitee to a calendar event. The total invitee rating value is determined by adding together the calendar event rating and the individual rating associated with an invitee for a particular event. For example, total invitee rating value 308 is determined by adding together 5 and 2, which are the calendar event rating value and the individual rating value, respectively, for individual 6 from FIG. 3A. The time slot rating associated with the Executive Staff Meeting is determined by adding total invitee rating values 308, 309, and 310, associated with Individual 6, Individual 7, and Individual 8, respectively, and dividing by the total number of invitees, 3, resulting in a time slot rating of 8.33.

FIG. 4 depicts a block diagram of components of computing device 120 and schedule information server 130, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing device 120 and schedule information server 130 each include communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media.

The programs user interface 121, calendar event data files 122, and scheduling feedback program 124 in computing device 120, and programs time slot data files 131 in schedule information server 130 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including between computing device 120 and schedule information server 130. In these examples, communications unit 410 includes one or more network interface cards. Communications unit 410 may provide communications through the use of either or both physical and wireless communications links. The programs user interface 121, calendar event data files 122, and scheduling feedback program 124 in computing device 120, and programs time slot data files 131 in schedule information server 130 may be downloaded to persistent storage 408 through communications unit 410.

I/O interface(s) 412 allows for input and output of data with other devices that may be connected to computing device 120 and schedule information server 130. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., the programs user interface 121, calendar event data files 122, and scheduling feedback program 124 in computing device 120, and programs time slot data files 131 in schedule information server 130, can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience and thus, the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for variable feedback for calendar reschedule operations, the method comprising:
receiving, by one or more processors, a first set of information for a first event, wherein the first set of information details a first time slot associated with the first event;
calculating, by one or more processors, a rating value for each of a plurality of time slots, based on the first set of information;
receiving, by one or more processors, information to reschedule the first event to a second time slot;
determining, by one or more processors, a resistance level based on the first set of information; and
applying, by one or more processors, a relative feedback based on the determined resistance level.

2. The method of claim 1, wherein determining a resistance level based on the first set of information further comprises:
receiving, by one or more processors, a set of rating values detailing each of a total plurality of time slots;
determining, by one or more processors, a resistance level of the first time slot, based on a first resistance factor, wherein the first resistance factor is determined based on a relative resistance level of the second time slot and the set of rating values detailing each of the total plurality of time slots; and
determining, by one or more processors, a resistance level of the second time slot, based on a second resistance factor, wherein the second resistance factor is determined based on a relative resistance level of the first time slot and the set of rating values detailing each of the total plurality of time slots.

3. The method of claim 2, wherein the step of applying, by the one or more processors, a relative feedback based on the determined resistance level further comprises:
determining, by one or more processors, a relative distance factor, wherein the relative distance factor is determined based on a total area of a user interface, a location of the first time slot in the user interface, and a location of the second time slot in the user interface;
determining, by one or more processors, a relative distance of the first time slot in the user interface to the second time slot in the user interface, based on the relative distance factor; and
generating, by one or more processors, a level of feedback associated with the relative distance of the first time slot in the user interface to the second time slot in the user interface, wherein the level of feedback is based on the location of the first time slot in the user interface relative to the location of the second time slot in the user interface.

4. The method of claim 1, wherein the relative feedback based on the determined resistance level further comprises one or more of a visual feedback, an audio feedback, and a haptic feedback.

5. The method of claim 1, wherein the first set of information further comprises:
an event rating, wherein the event rating is a relative value based on a type of event; and
an individual rating, wherein the individual rating is an assigned value based on a role of an invitee to the type of event.

6. The method of claim 5, wherein the step of calculating, by the one or more processors, the rating value for each of the plurality of time slots further comprises a calculation of a mean value of the event rating and the individual rating.

7. A computer program product for variable feedback for calendar reschedule operations, the computer program product comprising:
a computer readable storage medium and program instructions stored on the computer readable storage medium, the program instructions comprising:
program instructions to receive a first set of information for a first event, wherein the first set of information details a first time slot associated with the first event;
program instructions to calculate a rating value for each of a plurality of time slots, based on the first set of information;
program instructions to receive information to reschedule the first event to a second time slot;
program instructions to determine a resistance level based on the first set of information; and
program instructions to apply a relative feedback based on the determined resistance level.

8. The computer program product of claim 7, wherein the program instructions to determine a resistance level based on the first set of information, further comprise:
program instructions to receive a set of rating values detailing each of a total plurality of time slots;
program instructions to determine a resistance level of the first time slot, based on a first resistance factor, wherein the first resistance factor is determined based on a relative resistance level of the second time slot and the set of rating values detailing each of the total plurality of time slots; and
program instructions to determine a resistance level of the second time slot, based on a second resistance factor, wherein the second resistance factor is determined based on a relative resistance level of the first time slot and the set of rating values detailing each of the total plurality of time slots.

9. The computer program product of claim 8, wherein the program instructions to apply a relative feedback based on the determined resistance level further comprise:
program instructions to determine a relative distance factor, wherein the relative distance factor is determined based on a total area of a user interface, a location of the first time slot in the user interface, and a location of the second time slot in the user interface;
program instructions to determine a relative distance of the first time slot in the user interface to the second time slot in the user interface, based on the relative distance factor; and
program instructions to generate a level of feedback associated with the relative distance of the first time slot in the user interface to the second time slot in the user interface, wherein the level of feedback is based on the location of the first time slot in the user interface relative to the location of the second time slot in the user interface.

10. The computer program product of claim 7, wherein the relative feedback based on the determined resistance level further comprises one or more of a visual feedback, an audio feedback, and a haptic feedback.

11. The computer program product of claim 7, wherein the first set of information further comprises:
an event rating, wherein the event rating is a relative value based on a type of event; and
an individual rating, wherein the individual rating is an assigned value based on a role of an invitee to the type of event.

12. The computer program product of claim 11, wherein the program instructions to calculate the rating value for each of the plurality of time slots further comprises a calculation of a mean value of the event rating and the individual rating.

13. A computer system for variable feedback for calendar reschedule operations, the computer system comprising:
one or more computer processors;
one or more computer readable storage media;
program instructions stored on the one or more computer readable storage media for execution by at least one of the one or more processors, the program instructions comprising:
program instructions to receive a first set of information for a first event, wherein the first set of information details a first time slot associated with the first event;
program instructions to calculate a rating value for each of a plurality of time slots, based on the first set of information;
program instructions to receive information to reschedule the first event to a second time slot;
program instructions to determine a resistance level based on the first set of information; and
program instructions to apply a relative feedback based on the determined resistance level.

14. The computer system of claim 13, wherein the program instructions to determine a resistance level based on the first set of information, further comprises:
program instructions to receive a set of rating values detailing each of a total plurality of time slots;
program instructions to determine a resistance level of the first time slot, based on a first resistance factor, wherein the first resistance factor is determined based on a relative resistance level of the second time slot and the set of rating values detailing each of the total plurality of time slots; and
program instructions to determine a resistance level of the second time slot, based on a second resistance factor, wherein the second resistance factor is determined based on a relative resistance level of the first time slot and the set of rating values detailing each of the total plurality of time slots.

15. The computer system of claim 14, wherein the program instructions to apply a relative feedback based on the determined resistance level further comprise:
program instructions to determine a relative distance factor, wherein the relative distance factor is determined based on a total area of a user interface, a location of the first time slot in the user interface, and a location of the second time slot in the user interface;
program instructions to determine a relative distance of the first time slot in the user interface to the second time slot in the user interface, based on the relative distance factor; and
program instructions to generate a level of feedback associated with the relative distance of the first time slot in the user interface to the second time slot in the user interface, wherein the level of feedback is based on the location of the first time slot in the user interface relative to the location of the second time slot in the user interface.

16. The computer system of claim 13, wherein the relative feedback based on the determined resistance level further comprises one or more of a visual feedback, an audio feedback, and a haptic feedback.

17. The computer system of claim 13, wherein the first set of information further comprises:
an event rating, wherein the event rating is a relative value based on a type of event; and
an individual rating, wherein the individual rating is an assigned value based on a role of an invitee to the type of event.

18. The computer system of claim 17, wherein the program instructions to calculate the rating value for each of the plurality of time slots further comprises a calculation of a mean value of the event rating and the individual rating.
